(19) United States
(12) Patent Application Publication
(10) Pub. No.: US 2025/0155383 A1
(43) Pub. Date: May 15, 2025

(54) RAIL DIAGNOSTIC INSPECTION APPARATUS

(71) Applicant: TESMEC S.P.A., Milano (MI) (IT)

(72) Inventors: Silvestro Di Gioia, Bitetto (BA) (IT); Gaetano Marinelli, Bari (BA) (IT); Francesco Tristano, Bari (BA) (IT); Luigi Dipalo, Bari (BA) (IT)

(21) Appl. No.: 18/837,501

(22) PCT Filed: Feb. 3, 2023
(86) PCT No.: PCT/IB2023/050951

§ 371 Date: Aug. 9, 2024

(30) Foreign Application Priority Data
Feb. 11, 2022 (IT) 102022000002567

(51) Int. Cl. G01N 23/20008; B61K 9/10; B61L 23/04

(52) U.S. Cl. CPC G01N 23/20008; B61K 9/10; B61L 23/042; G01N 2223/3303; G01N 2223/401; G01N 2223/646

(57) ABSTRACT

A rail diagnostic inspection apparatus (10) especially of the railway track type, comprising radiogenic means for interacting with rails (16) for detection of defects (30) of said rails and means for analysis of said defects (30), said apparatus being stabilised to a diagnostic/inspection train or wagon (22) movable on said rails (16).

The present invention relates to a rail diagnostic inspection apparatus.

More in particular, the present invention relates to a rail diagnostic inspection apparatus of the railway track or subway track type or other similar types.

As is known, the rails (in particular, but not exclusively, rails of the railway type) define a fundamental element/component of a track and are, typically, mounted in opposing and parallel pairs, except in cases, for example, of “dual gauge” in which the rails may be three or four in number per track.

The rails are generally made of steel and maintaining them in proper condition is of paramount importance by virtue of the fact that the condition of the rails significantly affects the reliability and the quality of the railway transport and, above all, the safety thereof; in fact, the degradation of the parts that make up the rail may also cause the derailment of the convoy moving along them, resulting in the tendency for serious consequences to persons or things transported or can affect the convoy and its components (wheels, axles, etc.) due to the stresses transmitted to it (for example, vibration-related stresses that may accelerate the propagation of any cracks in the rails).

During operation, the rails may be subject to numerous failures classified (as to type and severity) according to the appearance assumed by said failures, these failures may be related to the presence of discontinuities originating from manufacturing defects or from the service of the rails themselves; if these discontinuities are not detected and not monitored, as previously indicated, they may also result in serious or very serious consequences.

Typically, in order to check the state of the rails an ultrasonic control using high frequency (32 Khz to 5 MHz) and directional sound waves is performed in order to measure the thickness of the materials, identify hidden defects, or analyse the properties of the materials; more specifically, the technique involves the generation of waves at a certain wavelength which propagate within the rail by mechanical stress, the wave in the presence of a defect is reflected in the direction of the wave-emitting source, which also acts as a receiver, and with the analysis of the return signal it is then possible to estimate the type of defect and its position.

The ultrasonic control can be performed manually by an operator who, moving along the tracks, moves a movable control device on one or both rails and interprets, through a display on a monitor, the data detected by the control device (this mode is also referred to as a “portable test process”).

Another ultrasonic control mode is implemented in an “automatic” manner by means of an apparatus that comprises a leading vehicle that, moving along the rails, performs the control of the defects and a trailing vehicle that performs the checks; in accordance with this control mode, when the leading vehicle detects a potential defect it communicates the position thereof to the trailing vehicle for the check and, in this case, the operator is only tasked with controlling whether a defect exists and communicating all the actual defects detected to put in place the appropriate interventions (this control mode is also known as “chase car process”).

However, this control methodology has major drawbacks related to the surfaces hit by the ultrasonic waves and the depth of their penetration into the thickness of the rail.

A further drawback of the ultrasonic control methodology is represented by the quality of the images or representations of the defect which, in this case, are poor as far as micrometre resolution is concerned.

Another drawback that characterises the ultrasonic control methodologies is related to the positioning and coupling of the ultrasonic probe with the rail; in fact, a non-perfect positioning/coupling of the probe with the rail may fail to detect a defect perhaps detected in a previous survey, and this problem also becomes even more evident if an ultrasonic probe is mounted under a diagnostic train, as the vibrations and the unstable position with respect to the rail may generate false defects or even fail to detect them.

The purpose of the present invention is to overcome the drawbacks listed above.

More in particular, the purpose of the present invention is to provide a rail diagnostic inspection apparatus (in particular, of the railway type) that allows to obtain a very clear, high-resolution image of any defect in the rail.

A further purpose of the present invention is to provide a diagnostic inspection apparatus that enables the evaluation of defects of the order of the micrometre.

A further purpose of the present invention is to provide a diagnostic inspection apparatus that does not require highly skilled personnel to check whether a defect is present (namely, to check whether it is true defect or whether it is a false defect).

A further purpose of the present invention is to make available to users a rail diagnostic inspection apparatus adapted to ensure a high durability and reliability over time.

These and other purposes are achieved by the apparatus of the invention which has the characteristics set forth in claim 1.

According to the invention a rail diagnostic inspection apparatus is provided especially of the railway track type, comprising radiogenic means for interacting with rails for detection of defects of said rails and means for analysis of said defects, said apparatus being stabilised to a diagnostic/inspection train or wagon movable on said rails.

Advantageous embodiments of the invention appear in the dependent claims.

The constructional and functional characteristics of the rail diagnostic inspection apparatus of the present invention may be better understood from the following detailed description, in which reference is made to the attached drawings which represent a preferred and non-limiting embodiment thereof and wherein:

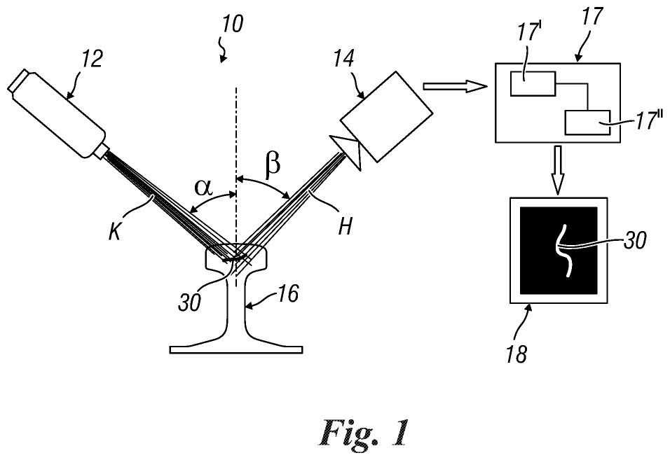

FIG. 1 illustrates a functional diagram of the rail diagnostic inspection apparatus of the invention;

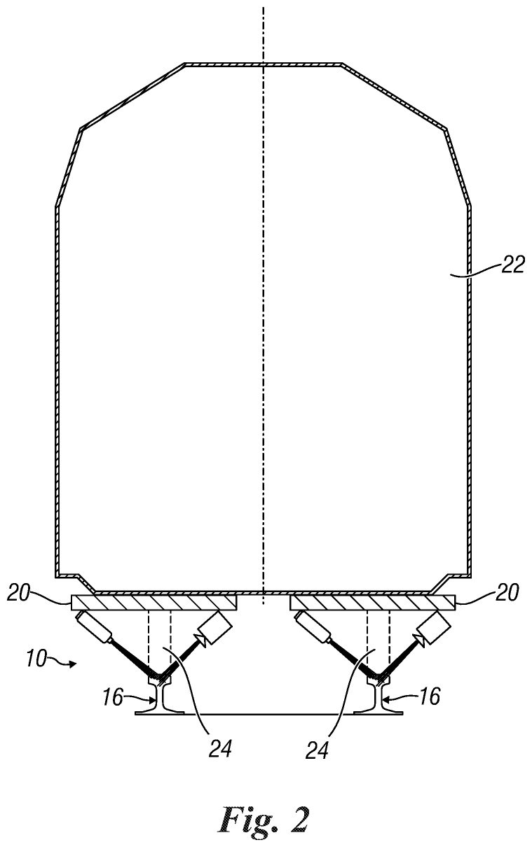

FIG. 2 schematically illustrates the rail diagnostic inspection apparatus of the present invention installed for use.

With reference to the aforementioned figures, the rail diagnostic inspection apparatus of the present invention, referred to collectively as 10, comprises a high-energy radiogenic source 12 and an X-ray detector 14 oriented (as further detailed below) in the direction of a rail 16 and a control unit 17 and a display unit 18.

The radiogenic source 12 is defined by an x-ray source which, as is known, consists of a device comprising an anode, a filament, a tungsten target, a vacuum glass casing that defines a container element for the filament and the target, and connecting filaments (for a connection between anode and cathode); the operation of the radiogenic source is based on the production of electrons at the filament which, due to the electric field generated between the anode and cathode at high voltage, are accelerated in the direction of the tungsten target, the collision of the electrons with the target generates the X-rays.

The X-ray detector 14, as is known, comprises a beryllium plate, a scintillator, a CMOS sensor (namely, an image sensor), and conditioning electronics.

The control unit 17 (defined, for example, by a personal computer) comprises a processing unit 17′ and one or more memory units 17″, with the processing unit 17′ comprising a computer vision algorithm based on artificial intelligence functional for analysing a set of images (which, in this specific case, are indicative of the presence or absence of a defect in the rail) in order to learn from this set to autonomously analyse and understand what can be considered as a defect and what, otherwise, should be discarded as nonconforming and this with an estimate of approximately 90% with reference to the images acquired by the X-ray detector 14; the processing unit 17′ may comprise a further algorithm functional to monitor the evolution of the detected defect over time by comparing the images detected during an ongoing control with the images saved in the one or more memory units 17″ and relative to previous inspections performed on the same rails 16 this is in order to be able to check the extent and the dangerousness of a defect 30 of the rail and to distinguish between a defect that may cause a line break and a non-serious defect.

The images processed by the processing unit 17′ of the control unit 17 are then sent to a display unit 18 (for example, a screen or similar) by means of which an operator will have the possibility to evaluate the images, the relative and possible defects in order to schedule maintenance, repair and similar interventions.

The diagnostic inspection apparatus is stabilised in the underbody 20 of a diagnostic/inspection train or wagon 22 with the radiogenic source 12 and the X-ray detector 14 opposed to each other and arranged to the right and to the left of a wheel 24 of said train running on rails 16 to be subjected to a control operation; the inspection/diagnostic train comprises a pair of opposed and parallel inspection apparatuses 10, one for each rail 16.

The radiogenic source 12 is stabilised to the underbody 20 and oriented so that the emitted rays hit the rail 16 with an angle of incidence “α” with respect to the vertical axis of the same rail, and the X-ray detector 14 is stabilised and oriented with respect to the underbody 20 so that it receives, with an angle of diffusion β (as a result of the diffusion or scattering phenomenon), the rays emitted by the radiogenic source 12 that hit the rail 16.

The images acquired by the X-ray detector 14 are sent to the control unit 17 by means of a wired connection or a wireless or wi-fi connection.

From an operating point of view, as the diagnostic/inspection train or wagon 22 runs along the rails 16, the X-ray beam (indicated by the reference “k” in FIG. 1) hits said rails, interacts with them and, as a result of diffusion or scattering of the incident beam, defines a deflected beam (indicated by the reference “H” in FIG. 1) that hits the X-ray detector 14 on which an image of the defect 30 is generated and is sent to the control unit 17 for processing.

By means of the computer vision algorithm of the processing unit 17′, the images acquired by the detector are analysed (said images can, in addition, be re-processed from any noise and similar) to check for the possible presence of a defect (as described previously, the algorithm distinguishes between what can be considered as a defect and what, on the other hand, must be discarded); any defect thus detected can be displayed on the display unit 18 (for example, a display) in order to be able to perform further analysis and/or processing of the image.

In addition, the processing unit 17′ can monitor the evolution of the detected defect over time by comparing the images detected during an ongoing control with the images saved in the one or more memory units 17″ and relative to previous inspections performed on the same rails 16 and this by means of a further algorithm functional for the purpose.

As can be seen from the foregoing, the advantages that the apparatus of the invention achieves are obvious.

The rail diagnostic inspection apparatus of the present invention, thanks to the use of X-rays, advantageously allows to perform a non-destructive type of control and to obtain a very clear image with high resolution and of the order of the micrometre of the possible defect present inside the rail.

A further advantage of the apparatus of the invention is represented by the fact that it is easy to use and does not require highly specialized personnel with reference to image checking; in fact, the operator performing the control has no difficulty in understanding whether or not an acquired radiographic image has a defect, unlike what takes place in the case of the ultrasonic control technique, which generates an ultrasound image for the interpretation of which considerable experience is required.

Further advantageous is the fact that the apparatus of the invention allows to examine the rail throughout its entire depth/thickness with the possibility of successively extracting the radiographic images with a pitch substantially less than 1 mm and this, consequently, leads to the related advantage of defining a volumetric control of the entirety of the inspected rail.

A further advantage of the apparatus of the invention is represented by the fact that it allows, by means of the processing algorithms, to monitor the state of development of any detected defect (normal, rapid, sudden growth) over time and, therefore, to schedule any maintenance interventions and/or replacement of the rail itself.

Further advantageous is the fact that by means of the diagnostic inspection apparatus of the invention it is possible to increase the safety of the rails and, consequently, the safety of the convoys that are moved on them.

Further advantageous is the fact that the diagnostic inspection apparatus of the invention has no problems in positioning and coupling with the rail and, therefore, the defect in the rail is always detectable.

Although the invention has been described above with particular reference to a preferred and non-limiting embodiment, numerous modifications and variations will appear obvious to a person skilled in the art in light of the above description. The present invention, therefore, is intended to embrace all the modifications and variations that fall within the scope of the following claims.

1. A rail diagnostic inspection apparatus (10), especially of the railway track type, characterised in that it comprises means for volumetric control of the entirety of a rail (16) that comprise radiogenic means for interacting with said rail (16) comprising a high-energy radiogenic source (12) and an X-ray detector (14) for detection of defects (30) and means for analysis of said defects (30), said apparatus being stabilised in an underbody (20) of a diagnostic/inspection train or wagon (22) movable on said rails (16) with the radiogenic source (12) and the X-ray detector (14) being opposed to each other and arranged one to the right and one to the left of a wheel (24) of said diagnostic/inspection train or wagon (22).

2. The apparatus according to claim 1, characterised in that the analysis means comprise a control unit (17) and a display unit (18).

3. The apparatus according to claim 2, characterised in that the control unit (17) comprises a processing unit (17′) and one or more memory units (17″).

4. The apparatus according to claim 3, characterised in that the processing unit (17′) comprises a computer vision algorithm based on artificial intelligence designed to analyse a set of images acquired by the X-ray detector (14) by diffusing or scattering an X-ray beam emitted by the high-energy radiogenic source (12) and incident on the rail (16).

5. The apparatus according to claim 3, characterised in that the processing unit (17′) comprises a further algorithm functional to monitor an evolution over time of a defect (30) detected on a rail (16) by comparing images detected during an ongoing control with images saved in the one or more memory units (17″) of the control unit (17).

6. The apparatus according to claim 1, characterised in that it is stabilised to the inspection/diagnostic train or wagon at each rail (16).

7. The apparatus according to claim 1, characterised in that the radiogenic source (12) stabilised to the underbody (20) is oriented so that the emitted rays hit the rail (16) with an angle of incidence “α” with respect to the vertical axis of the same rail, and the X-ray detector (14) is stabilised and oriented with respect to the underbody (20) in order to receive, with an angle of diffusion β, the rays emitted by the radiogenic source (12) that hit the rail (16).

8. The apparatus according to claim 1, characterised in that the images acquired by the X-ray detector (14) are sent to the control unit (17) by means of a wired connection.

9. The apparatus according to claim 1, characterised in that the images acquired by the X-ray detector (14) are sent to the control unit (17) by means of a wireless or wi-fi connection.
